(19) United States
(12) Patent Application Publication
(10) Pub. No.: US 2019/0082880 A1
(43) Pub. Date: Mar. 21, 2019

(54) REMOVAL DEVICE FOR BREWING MATERIAL

(71) Applicant: EVAN BRYON KAUFMAN, RICHMOND, VA (US)

(72) Inventor: EVAN BRYON KAUFMAN, RICHMOND, VA (US)

(21) Appl. No.: 16/131,208

(22) Filed: Sep. 14, 2018

Related U.S. Application Data
(60) Provisional application No. 62/559,270, filed on Sep. 15, 2017.

(51) Int. Cl. A47J 31/20; A47J 31/60

(52) U.S. Cl. CPC A47J 31/20; A47J 31/60

(57) ABSTRACT

The present invention is generally directed to a removal device for the removal of granular solid food material from a brewing device, the brewing device including a vessel and a plunger assembly, the removal device including a cylindrical cup having an outer diameter substantially the same size as an inner diameter of the vessel, comprising: a bottom surface, the bottom surface comprising one or more opening or apertures, the one or more openings or apertures covered by a mesh or screen material; a side wall; a protrusion disposed in the center of the bottom surface and protruding into the cup; and one or more magnets disposed in the protrusion. In some embodiments the protrusion may have a top surface configured to reduce or prevent accumulation of granular solid food material thereon, and the side wall may include one or more portions comprising a notch, cut-out, or reduced height.

### RELATED APPLICATIONS

This application claims priority to U.S. Provisional Patent Application No. 62/559,270, filed on 15 Sep. 2017, entitled “French Press Coffee Grounds Removal Device,” which is incorporated herein by reference in its entirety.

### BACKGROUND

In general, the present invention is directed to a device for the removal of brewing material (e.g., coffee grounds, tea leaves, etc.) from a brewing device. More specifically, the present invention is directed to a device that is introduced into a brewing device, such as but not limited to, a coffee press, and is engageable with a plunger of the brewing device to withdraw the brewing material while the brewed liquid may remain.

Coffee press devices (otherwise known as French presses, coffee plungers, cafetiére, etc.) are frequently used to brew coffee or tea to a user's specific tastes. However, such devices have at least two (2) notable drawbacks. First, such devices may be difficult to clean. The coffee grounds or tea leaves that were introduced into the device are often difficult to easily remove, particularly while preventing such coffee grounds or tea leaves from being washed down a drain. Since many coffee press devices include a vessel, or beaker, made of glass, particular care must be taken when cleaning to avoid breaking the device.

Second, since the brewing material (the coffee ground or tea leaves) are held in the water in order to infuse the flavor, the degree of infusion is based at least in part on time. In other words, coffee poured and consumed just after brewing will have a different taste profile than coffee poured and consumed ten minutes after allowing the grounds to infuse the liquid.

Accordingly, there is a need for a device that can simplify clean-up of a coffee press device. There is also a need for a device that can remove the brewing material from the liquid, while the liquid remains in the device, such that infusion can be stopped and a taste profile can be obtained.

### SUMMARY OF THE INVENTION

Aspects of the invention, in accordance with some embodiments, may include a removal device for the removal of granular solid food material from a brewing device, the brewing device comprising a vessel and a plunger assembly, the removal device comprising a cylindrical cup having an outer diameter substantially the same size as an inner diameter of the vessel, comprising: a bottom surface, the bottom surface comprising one or more opening or apertures, the one or more openings or apertures covered by a mesh or screen material; a side wall; a protrusion disposed in the center of the bottom surface and protruding into the cup; and one or more magnets disposed in the protrusion.

Other aspects in accordance with some embodiments of the present invention may include a removal device for the removal of granular solid food material from a brewing device, the brewing device comprising a vessel and a plunger assembly, the removal device comprising a cylindrical cup having an outer diameter substantially the same size as an inner diameter of the vessel, comprising: a bottom surface, the bottom surface comprising one or more opening or apertures, the one or more openings or apertures covered by a mesh or screen material; a side wall, having a height substantially the same as a height of the protrusion, and comprising one or more portions comprising a notch, cut-out, or reduced height; a protrusion disposed in the center of the bottom surface and protruding into the cup, the protrusion comprising a center hole that is coaxial with an axis of the cup, the protrusion having a top surface, the top surface being configured to reduce or prevent accumulation of granular solid food material thereon; and one or more neodymium magnets disposed in the protrusion.

Other aspects in accordance with some embodiments of the present invention may include a removal device for the removal of granular solid food material from a brewing device, the brewing device comprising a vessel and a plunger assembly, the removal device comprising a cylindrical cup having an outer diameter substantially the same size as an inner diameter of the vessel, comprising: a bottom surface, the bottom surface comprising one or more opening or apertures, the one or more openings or apertures covered by a mesh or screen material; a side wall, having a height substantially the same as a height of the protrusion, and comprising one or more portions comprising a notch, cut-out, or reduced height; a protrusion disposed in the center of the bottom surface and protruding into the cup, the protrusion comprising a center hole that is coaxial with an axis of the cup, the protrusion having a top surface, the top surface having a point or crown to reduce or prevent accumulation of granular solid food material thereon; and the protrusion further comprising a ring neodymium magnet that encircles the center hole in the protrusion.

These and other aspects will become apparent from the following description of the invention taken in conjunction with the following drawings, although variations and modifications may be affected without departing from the spirit and scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary coffee press device, in accordance with some embodiments of the present invention.

FIG. 2 illustrates an exemplary plunger of a coffee press device, in accordance with some embodiments of the present invention.

FIG. 3 shows an exemplary removal device, in accordance with some embodiments of the present invention.

FIG. 4 illustrates a bottom surface of an exemplary removal device, in accordance with some embodiments of the present invention.

FIG. 5 illustrates a cross-sectional view of an exemplary removal device, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

As noted above, the present invention is generally directed to a device for the removal of brewing material (e.g., coffee grounds, tea leaves, etc.) from a brewing device. More specifically, the present invention is directed to a device that is introduced into a brewing device, such as but not limited to, a coffee press, and is engageable with a plunger of the brewing device to withdraw the brewing material while the brewed liquid may remain.

The present invention is an accessory to coffee presses that eases in the removal of spent brewing material. Before discussing the details of the present invention, an understanding of a coffee press may be useful. A coffee press is a relatively simple device comprising a beaker or carafe (often made from glass, stainless steel, plastic, etc.), a lid with a central hole, and a plunger. The plunger generally has a central handle that is disposed through the central hole in the lid. The plunger may be comprised of various materials, but often uses mesh, screens, etc. provide a filter and maintain the brewing material (e.g. coffee grounds, tea leaves, etc.) on one side of the plunger, while allowing a fluid to pass through the plunger.

A brewing material and a liquid (usually water) may be added into the beaker, and optionally mechanically mixed. The plunger, which may be fitted against the walls of the beaker, may then be placed into the beaker, and the top engaged with the top of the beaker. At a desired time (which may be based on the strength of the brew, the type of brewing material, time of infusion, etc.), the plunger handle may be pressed down, causing the plunger to slide down the beaker, and infused liquid to pass through the mesh, screen, or filter to the other side of the plunger. The brewing material may be maintained on one side of the plunger due to both the mesh, screen, or filter, as well as the fit of the plunger against the walls of the beaker (which may prevent the brewing material from escaping around the plunger).

When the plunger is pushed all the way down, the brewing material may be maintained at the bottom of the beaker, and the liquid may be poured out of the coffee press into cups to be enjoyed.

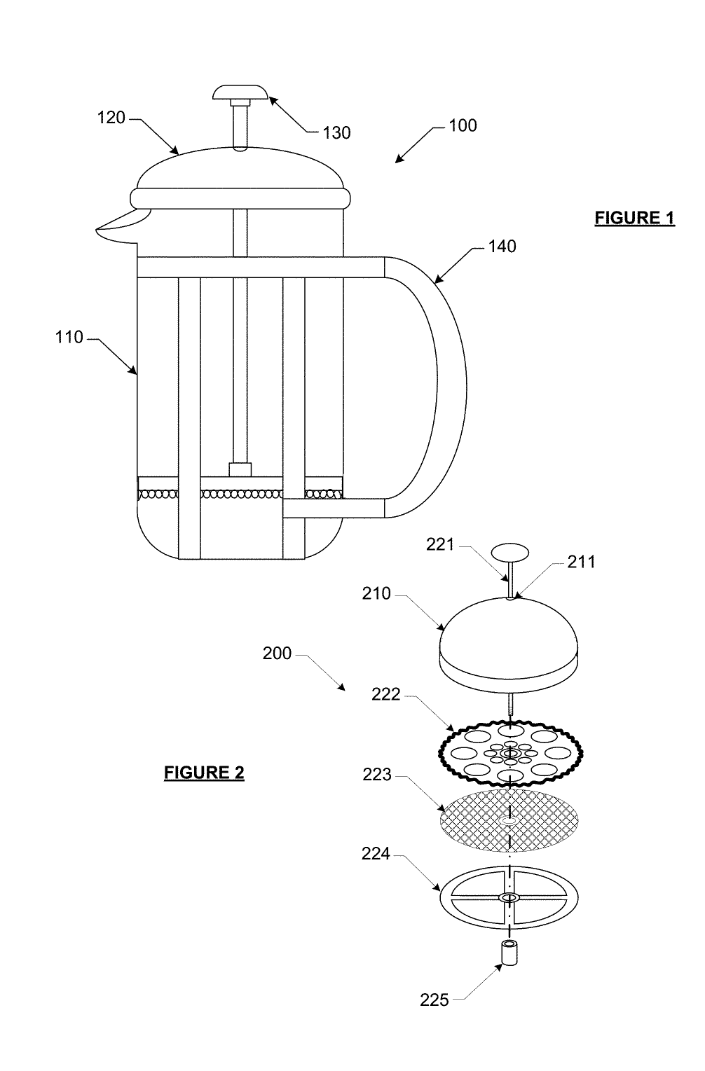

With reference to FIG. 1A, an exemplary coffee press device 100 is presented. The coffee press device 100 may comprise a beaker 110, a lid 120, and a plunger 130. Note that the device may optionally include a handle 140 for ease of use.

FIG. 2 illustrates an exploded view of an exemplary plunger and lid. Lid 210 may comprise a center hole 211, through which a plunger rod 221 may be disposed. Plunger rod 221 may be connected to one or more filtration and/or support devices, which may include (but are not limited to) a spiral plate 222, filter screen 223, a cross plate stem 224. These may be attached to the plunger rod 221 through the use of a retaining nub 225, which may be attached to the plunger rod through any variety of means known in the art (such as, but not limited to, threaded engagement, adhesive, crimping, set screws, rivets, etc.). However, it is notable that most retaining nubs are of a ferromagnetic composition.

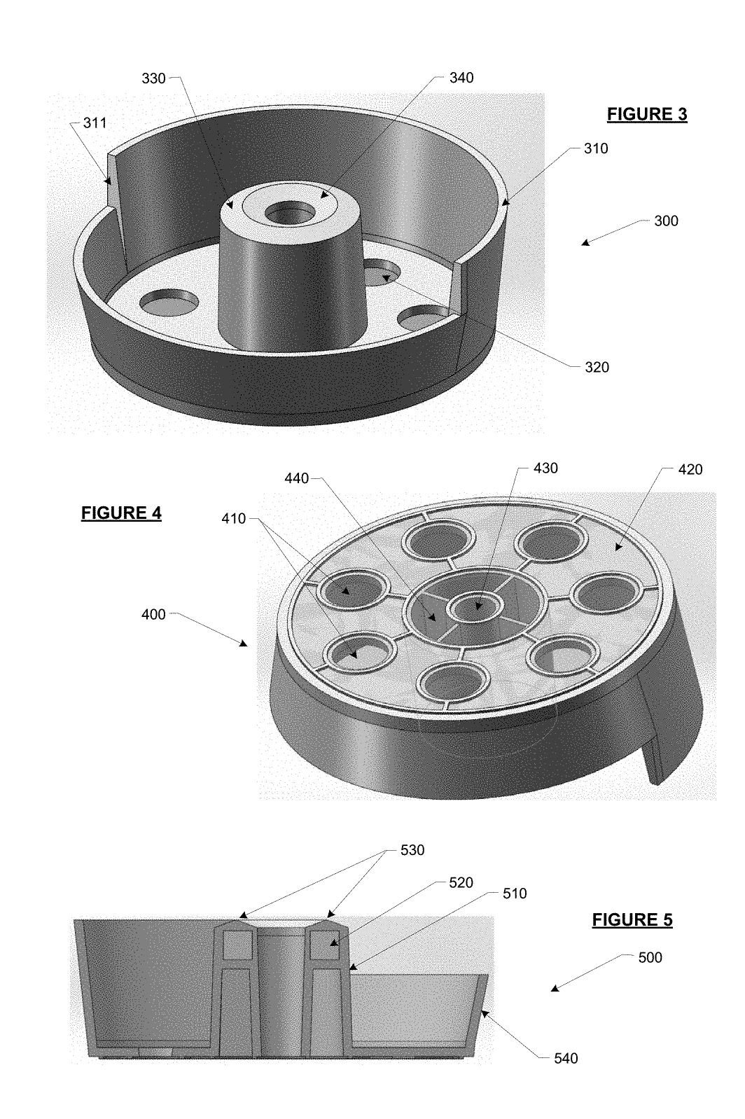

FIG. 3 illustrates an exemplary removal device 300 in accordance with some embodiments of the present invention. Removal device 300 may comprise a cup 310 with a bottom surface and sidewall, which may be sized to the diameter of a coffee press beaker. The bottom surface of the cup 310 may include one or more holes 320, which may be covered with a mesh, screen, or filter. Holes 320 may be utilized to reduce the amount of strain on the magnetic connection, as it may be helpful to allow the infused liquid to flow from the removal device. However, it is also contemplated that this device may be manufactured and utilized without holes.

There may be a protrusion 330 in the center of the cup 310. The protrusion 330 may be sized to be substantially equal in height to, or taller than, the side walls of the cup 310.

One or more magnets 340 may be disposed in the protrusion 330. FIG. 3 illustrates a single ring magnet 340. However, note that it is contemplated that the arrangement of the magnets may vary. For example, rather than a ring magnet, there may be two (2) or more smaller magnets arranged in the protrusion 330. The magnet 340 may be configured to provide magnetic engagement with the plunger. The magnet may be engage with, for example, the filter plate or the retaining nub at the bottom of the plunger rod. In accordance with some embodiments of the present invention, a ring magnet may be used so that the retaining nub may enter the center orifice of the magnet, and the magnet may achieve a strong connection with the filter plate.

Magnet 340 may be any type of magnet. Note that it is contemplated that an electromagnet could be used; however, for ease of description permanent magnets will be discussed. Various types of permanent magnets may be used, including but not limited to ferrite magnets, alnico magnets (that is, magnets comprise of an alloy of aluminum, nickel, and cobalt), neodymium iron boron (NdFeB) magnets (“neodymium magnets”), and/or

samarium cobalt (SmCo) magnets. However, the magnetic force required to maintain connection during removal from the beaker may require a stronger magnetic connection, such as those offered by rare-earth magnets, such as neodymium magnets or samarium-cobalt magnets.

In operation, the removal device may be placed within the beaker of a coffee press device. Brewing material (such as coffee grounds, tea leaves, etc.) may be added into the beaker, and into or on top of the removal device. In accordance with typical brewing, water may be added and the mixture allowed to infuse. When infusion is complete the user may push the plunger to the bottom of the beaker, thereby forcing the brewing material into the removal device. When the plunger is pressed down sufficiently, the magnet 340 may engage the retaining nub on the plunger. At this point, the user may slowly remove the plunger and removal device together, thereby removing the spent brewing material from the infused liquid. This may result in both quicker clean up and may prevent further infusion (thereby maintaining the taste profile at a certain point).

With reference to FIG. 4 a bottom surface of an exemplary removal device 400, in accordance with some embodiments of the present invention can be seen. The removal device 400 may include the one or more holes 410, which may be covered by a mesh, screen for filter 420. For example, the mesh, screen, or filter may comprise a stainless-steel mesh screen that may extend over the entire bottom surface of the removal device, a portion of the bottom surface, or may be disposed only over the holes 420. The size of the mesh may vary and may be selected based on various design choices; however, the mesh must be effective at preventing the brewing material from passing there through.

In addition to the basic functionality of the removal device as discussed above, some embodiments of the present invention may include features that may increase the functionality, efficiency, operation, and/or convenience of the device. For example, with renewed reference to FIG. 3 note that the sidewall of the cup 310 may have a cut out, or reduced height portion 311. When the removal device 310 is in engagement with the retaining nub, it may be difficult to easily remove the device from the plunger and nub without causing a mess with the brewing material. However, the inclusion of the cut out or reduced height portion 311 allows for easier removal. A user can either use the opening as a finger hold in prying the removal device 300 off of the plunger or can press on the cut out or reduced height portion 311, thereby causing a moment rotating about the magnet, and resulting in easier removal.

Another example of increased functionality may be seen in FIG. 5, which depicts a cross section of an exemplary removal device 500 in accordance with some embodiments of the present invention. As shown in previous figures, the removal device 500 may comprise a center protrusion 510. One or more magnets 520 may be disposed at the top of the protrusion 510. Note that such magnets may be fully encased in the material of the removal device 500 (such as embedded in a plastic-injected molded product), partially encased (such as due to mechanical attachment, such a compression fit or adhesive), or attached (such as due to adhesive). Note that the top of the protrusion has a peak, or crown 530. This peak or crown 530 prevents excess brewing material from accumulating between the magnet 520 and the retaining nub of the plunger. A flat surface may accumulate brewing material, which may impact the magnetic attachment between the magnet and the plunger. A non-flat surface—such as the peak or crown shown—may prevent this issue. Note that various other features—such as multiple peaks, a rounded crown, a single angled top surface, etc. are contemplated by the present invention. The functional component of reducing brewing material accumulation between the magnet and plunger is what is relevant.

In addition to preventing accumulation of granular solid food material (i.e., brewing material), the peaks or crowns 530 of the protrusion may also provide an additional assist. Specifically, when the plunger of the coffee press is pressed down, it is not uncommon for the brewing material, such as coffee grounds, to build up on the bottom of the plunger as it is pushed through the liquid in the beaker. When the plunger meats the device, a twist of the plunger (for example, spinning the handle about the center axis) may cause the peak or crown 530 to penetrate any grounds that may have accumulated on the plunger—for example, on the filter plate—thereby helping create a strong magnetic connection that is not, or at least is less, impeded by the accumulation of granular solid food material.

Another example of increased functionality may be the angled walls 540 of the cup, as seen in FIG. 5. The angle in the cup walls may allow for less direct contact between the outer diameter surface of the cup and a breaker in to which the removal device is inserted. That is, the contact between the glass wall of the beaker and the device would be limited to the top surface of the cup, with the largest diameter. This reduced contact area may permit for easier insertion and removal of the device from the beaker.

Note that the protrusion may be designed and/or configured in different ways. For example, it is contemplated that the protrusion may include one or more holes or apertures, that may allow for granular solid food material to pass through the protrusion without clogging.

It will be understood that the specific embodiments of the present invention shown and described herein are exemplary only. Numerous variations, changes, substitutions and equivalents will now occur to those skilled in the art without departing from the spirit and scope of the invention. For example, it is contemplated that the magnet may be removable from the removal device. In such circumstances, rather than embedding or attaching the magnet to the removal device, the removal device may be manufactured with metal in the protrusion, and the magnet may cause connectivity between the removal device and the plunger. Similarly, two (2) magnets may be used—one in the removal device and one attached to the plunger, the magnets arranged to be attracted to each other and create a stronger magnetic connection. Moreover, the specific arrangement of the crown, the cut-out or reduced height area, the holes in the bottom of the device, and other such features may vary. Accordingly, it is intended that all subject matter described herein and shown in the accompanying drawings be regarded as illustrative only, and not in a limiting sense, and that the scope of the invention will be solely determined by the appended claims.

What is claimed is:

1. A removal device for the removal of granular solid food material from a brewing device, the brewing device comprising a vessel and a plunger assembly, the removal device comprising a cylindrical cup having an outer diameter substantially the same size as an inner diameter of the vessel, comprising:
a bottom surface, the bottom surface comprising one or more opening or apertures, the one or more openings or apertures covered by a mesh or screen material;
a side wall;
a protrusion disposed in the center of the bottom surface and protruding into the cup; and
one or more magnets disposed in the protrusion.

2. The removal device of claim 1, wherein the protrusion comprises a center hole that is coaxial with an axis of the cup, the protrusion having a top surface, the top surface being configured to reduce or prevent accumulation of granular solid food material thereon.

3. The removal device of claim 2, wherein the top surface has a point or crown to reduce or prevent accumulation of granular solid food material thereon.

4. The removal device of claim 1, wherein the one or more magnets comprise neodymium magnets.

5. The removal device of claim 2, wherein the one or more magnets comprise a ring magnet that encircles the center hole in the protrusion.

6. The removal device of claim 5, wherein the plunger assembly includes a filter plate and a retaining nub, the retaining nub positioned at the bottom of the plunger assembly, and wherein the center hole in the protrusion receives the retaining nub such that the ring magnet magnetically engages with the filter plate.

7. The removal device of claim 1, wherein the sidewall has one or more portions comprising a notch, cut-out, or reduced height.

8. The removal device of claim 1, wherein the sidewall has a height substantially the same as a height of the protrusion.

9. The removal device of claim 8, wherein the sidewall has one or more portions with a height less than the height of the protrusion.

10. The removal device of claim 1, wherein the mesh or screen material covering the one or more opening or apertures permits the flow of liquid therethrough, but substantially inhibits the passage of the granular solid food material therethrough.

11. A removal device for the removal of granular solid food material from a brewing device, the brewing device comprising a vessel and a plunger assembly, the removal device comprising a cylindrical cup having an outer diameter substantially the same size as an inner diameter of the vessel, comprising:
a bottom surface, the bottom surface comprising one or more opening or apertures, the one or more openings or apertures covered by a mesh or screen material;
a side wall, having a height substantially the same as a height of the protrusion, and comprising one or more portions comprising a notch, cut-out, or reduced height;
a protrusion disposed in the center of the bottom surface and protruding into the cup, the protrusion comprising a center hole that is coaxial with an axis of the cup, the protrusion having a top surface, the top surface being configured to reduce or prevent accumulation of granular solid food material thereon; and
one or more neodymium magnets disposed in the protrusion.

12. The removal device of claim 11, wherein the top surface has a point or crown to reduce or prevent accumulation of granular solid food material thereon.

13. The removal device of claim 11, wherein the one or more magnets comprise a ring magnet that encircles the center hole in the protrusion.

14. A removal device for the removal of granular solid food material from a brewing device, the brewing device comprising a vessel and a plunger assembly, the removal device comprising a cylindrical cup having an outer diameter substantially the same size as an inner diameter of the vessel, comprising:
a bottom surface, the bottom surface comprising one or more opening or apertures, the one or more openings or apertures covered by a mesh or screen material;
a side wall, having a height substantially the same as a height of the protrusion, and comprising one or more portions comprising a notch, cut-out, or reduced height;
a protrusion disposed in the center of the bottom surface and protruding into the cup, the protrusion comprising a center hole that is coaxial with an axis of the cup, the protrusion having a top surface, the top surface having a point or crown to reduce or prevent accumulation of granular solid food material thereon; and
the protrusion further comprising a ring neodymium magnet that encircles the center hole in the protrusion.

15. The removal device of claim 14, wherein the plunger assembly includes a filter plate and a retaining nub, the retaining nub positioned at the bottom of the plunger assembly, and wherein the center hole in the protrusion receives the retaining nub such that the ring magnet magnetically engages with the filter plate.
